(19) United States
(12) Patent Application Publication
(10) Pub. No.: US 2013/0132987 A1
(43) Pub. Date: May 23, 2013

(54) OFFERING TASKS TO USERS BASED ON THEIR COMPETENCE AND ON THEIR CURRENT ACTIVITY

(71) Applicants: Nitya Narasimhan, Hopewell Junction, NY (US); Venugopal Vasudevan, Palatine, IL (US); Joseph F. Wodka, Hoffman Estates, IL (US)

(72) Inventors: Nitya Narasimhan, Hopewell Junction, NY (US); Venugopal Vasudevan, Palatine, IL (US); Joseph F. Wodka, Hoffman Estates, IL (US)

(73) Assignee: GENERAL INSTRUMENT CORPORATION, Horsham, PA (US)

(21) Appl. No.: 13/301,080

(22) Filed: Nov. 21, 2011

(51) Int. Cl. H04H 60/32

(52) U.S. Cl. 725/14

(57) ABSTRACT

The pervasive visibility of television and other screens is leveraged to present task offers to users. A task broker gives the user an incentive if he accepts and successfully performs the task. To be effective, the task broker first collects profile information about the user. Some of the profile information is used to determine what tasks are appropriate for a given user based, for example, on that user's competencies. Other profile information characterizes the user's current level of activity and, based on that, his “interruptibility.” Tasks and incentives can be chosen based on user-profile information including, for example, demographics and the user's previous interactions with the task broker. Information about the user's successful completion of a task can be used to update the user's profile, and future task offers are based on this updated profile information.

### FIELD OF THE INVENTION

The present invention is related generally to television-content delivery systems and, more particularly, to offering tasks to people using those systems.

### BACKGROUND OF THE INVENTION

Industry reports show (a) that viewers are spending more time than ever watching television and (b) that the average U.S. home has more televisions than people (2.86 televisions for 2.5 people). These reports lead to the conclusion that the television is one of the most pervasively visible displays in the home, from the user's perspective. That said, industry reports also show that users often “multi-task” while the television is on, that is, they sometimes focus their attention on other displays and not necessarily on the television. Still, the users are at most times at least peripherally aware of the content that the television is displaying.

Taking advantage of this prominence of television, modern television sets (and their associated set-top boxes) are beginning to provide interactive and social applications in addition to the traditional “content-consumption” experiences (e.g., broadcast programming). For example, a television screen can show an interactive user interface overlaid onto the television's traditional streaming content, the user interface supporting an application that complements the streaming content (e.g., an interactive sports interface overlaid onto a sports network feed). In another example, the television screen becomes yet another display, in addition to the displays of home computers, smart telephones, and other user devices, for Internet-based user applications. For some of these applications, content is “pulled down” from the Internet for display on the television. In more sophisticated applications, third-party web providers “push” content down to a television that supports a fully bidirectional interaction.

Many television-content providers classify interactive applications as either “bound” or “unbound.” Bound applications are tightly coupled to a particular television channel (e.g., a news ticker coupled to a news channel or a fantasy football application coupled to a sports channel), and bound applications are authorized by and often provided by the channel provider. A bound application only appears when the user tunes to the associated channel, and the bound application disappears when the user tunes to another channel. In contrast, an unbound application is not associated with any particular television channel and can be accessed regardless of the channel that the user is currently watching. Examples of unbound applications include a television program guide, an on-demand menu, and a user interface for controlling a digital video recorder or a set-top box.

Generally, both bound and unbound interactive applications appear in response to an explicit user request (e.g., via a menu selection from the user's remote control). Both types of applications are inherently “synchronous:” Bound applications are tied to a channel-selection event, and unbound applications are tied to user-input events. Both types of applications are orchestrated: bound applications by the channel provider, and unbound applications by the user or by the television provider.

### BRIEF SUMMARY

The above considerations, and others, are addressed by the present invention, which can be understood by referring to the specification, drawings, and claims. The pervasive visibility of television and other screens is leveraged, according to aspects of the present invention, to present task offers to users. A task broker gives the user an incentive if he accepts and successfully performs the task. To be effective, the task broker first collects profile information about the user. Some of the profile information is used to determine what tasks are appropriate for a given user based, for example, on that user's competencies. Other profile information characterizes the user's current level of activity and, based on that, his “interruptibility.” If the user is watching a highly contested sporting event, for example, then the task may be offered only after the event is over, when the user is expected to be more willing to perform it.

In some embodiments, the task broker sends the offer to a device associated with the target user, e.g., the user's set-top box. The set-top box monitors the activities of the user and presents the offer at an appropriate time. The offer may be presented in, for example, a pop-up displayed on the user's television.

Many types of tasks and many types of incentives are contemplated. Several examples are discussed below. Tasks and incentives can be chosen based on user-profile information including, for example, demographics and the user's previous interactions with the task broker.

The “owner” or sponsor of a particular task can give explicit criteria to the task broker that narrow the range of acceptable offerees of the sponsor's task. The sponsor can “bind” the task so that it is only presented during a specified television program, for example. A task can also be associated with a completion-acceptance criterion, and user must satisfy that criterion in order to merit the incentive. If, for example, the task is not completed by a certain time, the sponsor can withdraw the offer.

Information about the user's successful completion of a task can be used to update the user's profile, and future task offers are based on this updated profile information.

### BRIEF DESCRIPTION OF THE SEVERAL VIEWS OF THE DRAWINGS

While the appended claims set forth the features of the present invention with particularity, the invention, together with its objects and advantages, may be best understood from the following detailed description taken in conjunction with the accompanying drawings of which:

FIG. 1 is an overview of a representational environment in which the present invention may be practiced;

FIG. 2 is a generalized schematic of some of the devices shown in FIG. 1;

FIGS. 3a and 3b together form a flowchart of a method performed by a representative task broker; and

FIGS. 4a and 4b together form a flowchart of a method performed by a representative user device.

### DETAILED DESCRIPTION

Turning to the drawings, wherein like reference numerals refer to like elements, the invention is illustrated as being implemented in a suitable environment. The following description is based on embodiments of the invention and should not be taken as limiting the invention with regard to alternative embodiments that are not explicitly described herein.

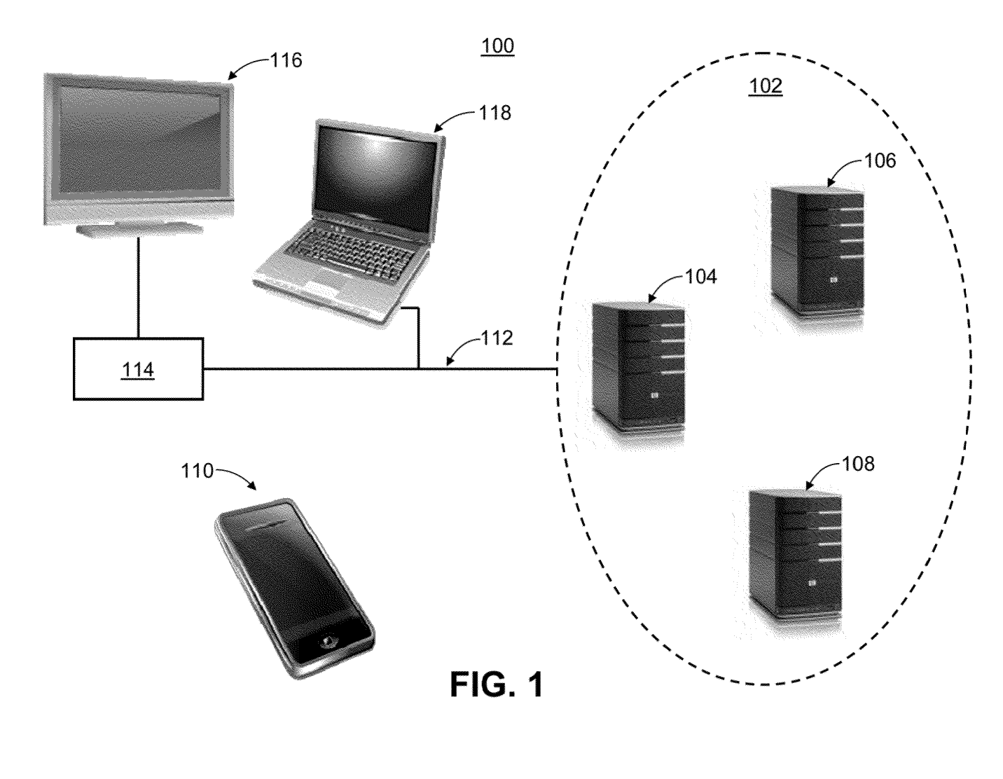

Aspects of the present invention may be practiced in the representative communications environment 100 of FIG. 1. Connected together via any or all of various known networking technologies 102 are servers such as channel providers 104, task brokers 106, and task sponsors 108. For ease of illustration, only one of each type of server 104, 106, 108 is shown, but multiples of each can exist and can work together, as discussed below.

The servers 104, 106 (and, indirectly, the task sponsor 108) provide, via the networking technologies 102, media-download and tasking services to end-user devices. One example of an end-user device is a cellular telephone 110. This telephone 110 communicates wirelessly to a wireless base station (not shown but known in the art) to access the public switched telephone network, the Internet, or other networks to access the services provided by the servers 104, 106.

Non-wireless end-user devices are supported by “wireline” network technologies (e.g., fiber, wire, and cable) 112. For example, a set-top box 114 generally receives television programming from various channel providers 104 and provides a user interface (e.g., an interactive program guide) for selecting and viewing content from the cable providers 104. A digital video recorder (not shown) can store programming for later viewing. Video content may be viewed on a television monitor 116. In some situations, a laptop computer 118 accesses web-based services either wirelessly or via the wireline network 112. A home gateway, kiosk, digital sign, or media-restreaming device (not shown) are other possible end-user devices.

(A media-restreaming device transfers content between disparate types of networks. For example, it receives content from a cable system 112 and then transmits that content over a local radio link such as WiFi to the cellular telephone 110. The media-restreaming device usually operates in both directions to carry messages between the networks. In some embodiments, aspects of the present invention are practiced by a media-restreaming device.)

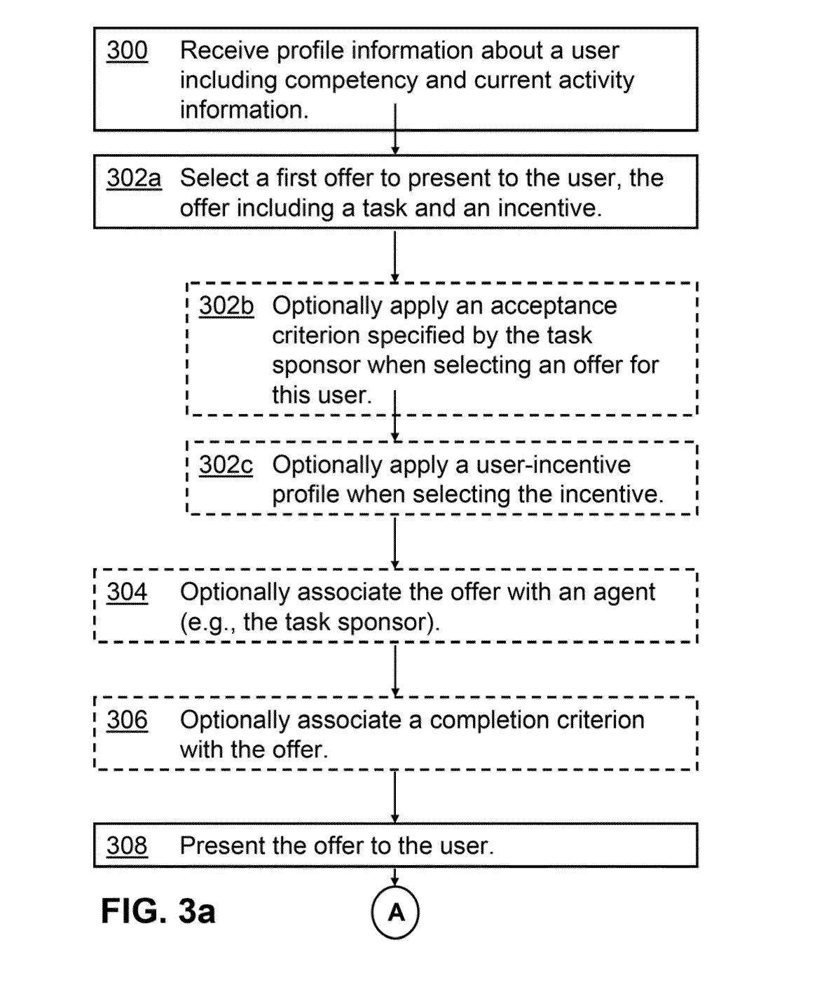

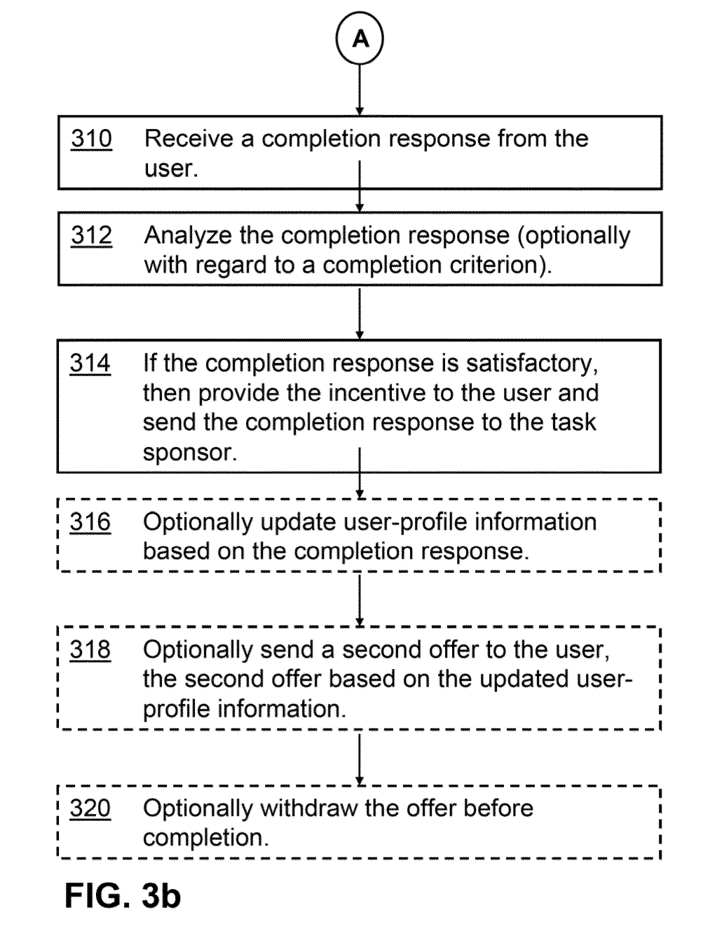

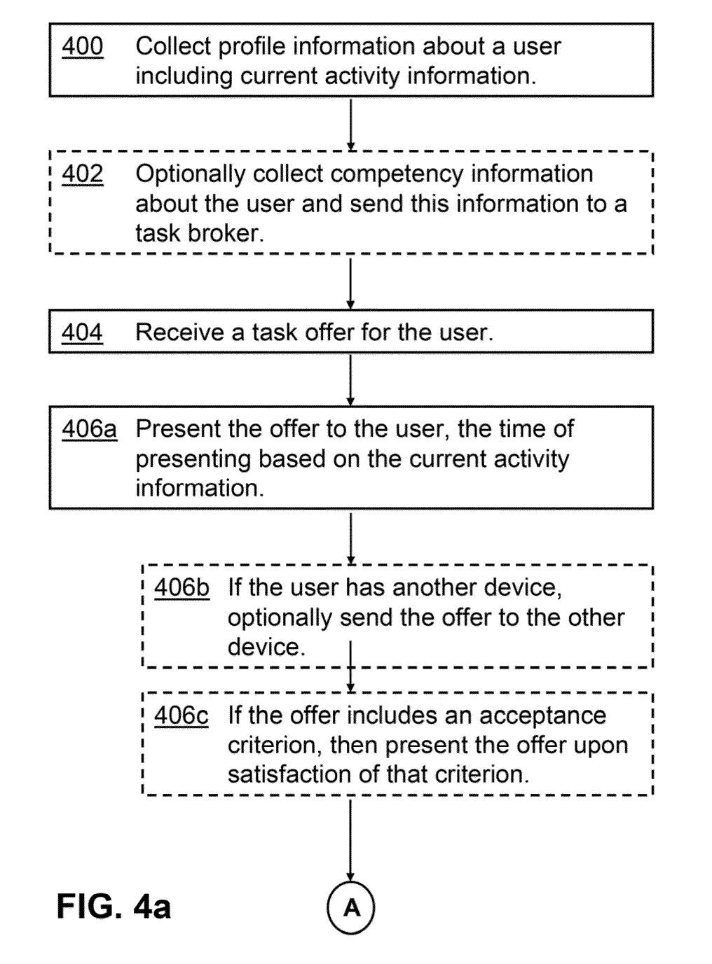

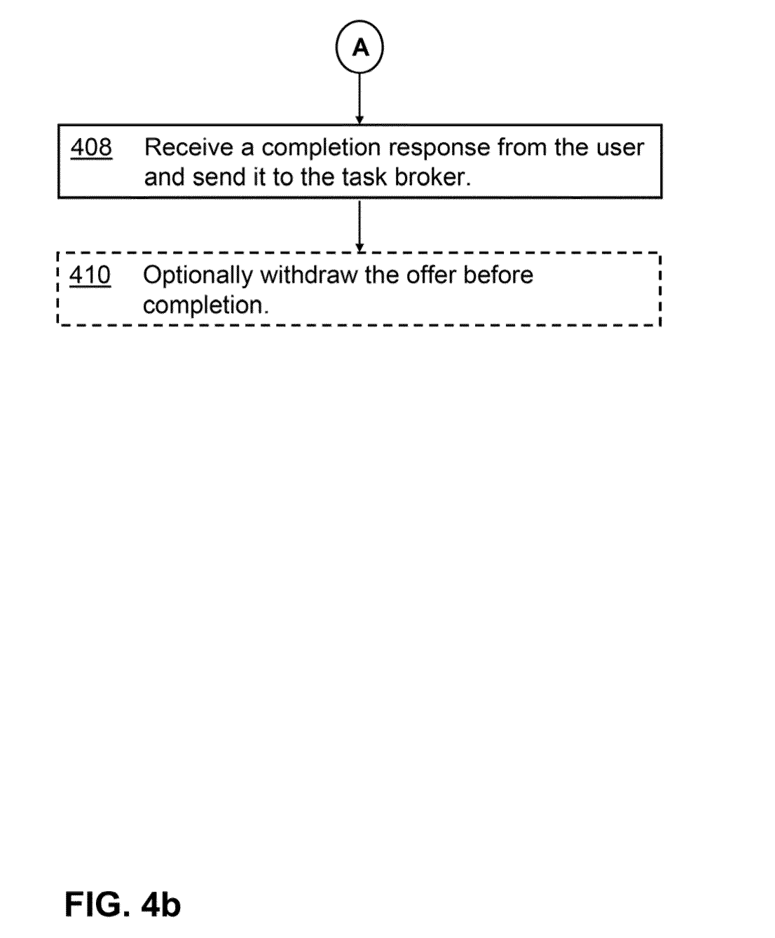

Of particular interest to the present discussion is the task broker 106. In general, the task broker 106 receives a task (possibly from a task sponsor 108), discovers an appropriate user for the task (based on information it receives about user competency and current activities), associates an incentive with the task, and presents the resulting offer to the user via the user's device 110, 114, 118. The task broker 106 also handles any subsequent interactions of the user with the offer. (Particular aspects of this function are discussed below in conjunction with FIGS. 3 and 4.) For the sake of simplicity, the present discussion assumes that the task broker functionality is fully embodied on the server 106, but in other embodiments the functions of a task broker can reside within the channel provider 104, on web servers, on an end-user device such as the set-top box 114, or on some combination of these.

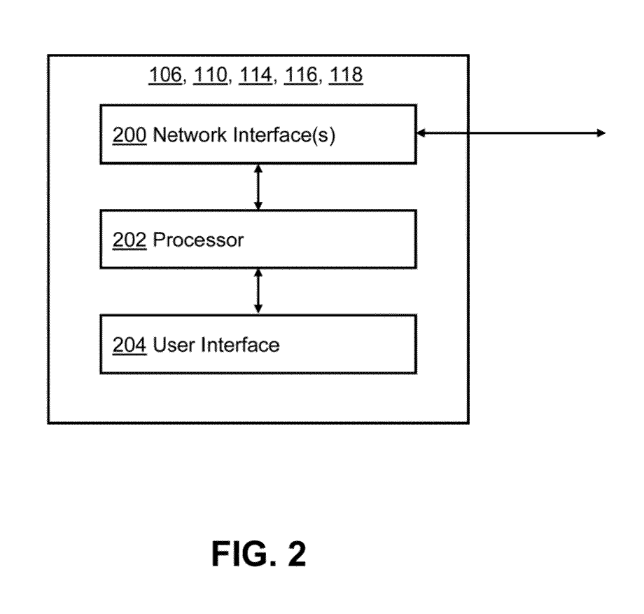

FIG. 2 shows the major components of a representative task broker 106 or end-user device 110, 114, 116, 118. Network interfaces 200 send and receive media presentations, related information, download requests, and, in particular, task offers and responses. A processor 202 controls the operations of the device and, in particular, supports aspects of the present invention as illustrated in FIGS. 3 and 4, discussed below. The user interface 204 supports a user's (or administrator's) interactions with the device. Specific uses of these components by specific devices are discussed as appropriate below.

The task broker 106 can proceed according to the method illustrated in FIG. 3. In step 300 of FIG. 3a, the task broker 106 receives information about potential offer recipients. The information includes both task-competency information and current activity information.

Task-competency can include educational status, success in completing past offers, explicitly stated user preferences, demographics, and even inferred profile information, such as, for example, that this user watches tennis frequently so he may well know something about the game and may be competent in performing jobs related to tennis.

Current activity information is used to determine how “interruptible” the user is. This information can include both explicitly stated user preferences (“do not send me offers during the weekend”) as well as information gleaned about the user's activities. For example, the user may be watching a football game featuring a team that he is known to be very fond of. This information may be used to conclude that the user is not very interruptible, at least not until half time. Interruptibility can also be based on the user's social context, that is, on who else is near him.

In step 302a, the task broker 106 uses the task-competency information, the current activity information, and any other potentially relevant information to select a user for a task (or to select a task for this user).

In step 302b, the sponsor of the task 108 can optionally set its own acceptance criteria for the task selection. If the task is related to an advertising campaign for a new product, for example, then the sponsor 108 may state that only recent buyers of a competing product are eligible to perform this task.

Along with an appropriate task, the task broker 106 selects an appropriate incentive in step 302a. Just about any type of incentive can be offered including a coupon, access to a game, “secret shopper” information, a service improvement, and the removal of a disincentive. In optional step 302c, the task broker 106 applies a user's incentive profile when selecting an appropriate incentive. The profile can include information about the user's past performance on other tasks. Of course, the task sponsor 108 usually has a large say as to what incentives it is willing to give to get its tasks performed.

The task broker 106 combines the selected task and the selected incentive into a job offer to complete step 302a.

Some offers are associated with a sponsoring agent in step 304. Often used in advertising, the association may make the user more willing to consider accepting the offer.

In step 306, a completion criterion (usually specified by the task sponsor 108) can be associated with the offer. If, for example, the completion of the task is only useful to the sponsor 108 if performed in the next few days, the completion criterion can state that. It is also possible for the sponsor 108 to state that the same job offer should be sent to a number of users but that only the first, say, ten responses will be accepted as meriting the incentive.

The offer is now complete and is presented to the user in step 308. (See also the discussion of FIG. 4 below.) There are numerous ways of presenting the offer to the user. It can be included in an advertisement shown on the television monitor 116, in an electronic message, as an item in a menu (such as an electronic program guide), or in a special application developed just for this purpose. If the user receives the offer in a shared environment (e.g., via the set-top box 114 at his home), then the offer may include some type of authentication requirement so that it is only presented to the correct user.

The user completes the job and sends a response to the task broker 106 in step 310 of FIG. 3b. The task broker 106 analyzes the response by applying the task sponsor's completion criteria, if any, in step 312. If all is satisfactory, then the task broker 106 forwards the completion response on to the task sponsor 108 in step 314 and provides the incentive to the user.

In step 316, information about the user's response (e.g., timeliness, correctness) is used to update the user's profile, and that profile is used when selecting further tasks for this user in step 318. By sending more tasks, the user's profile expands and becomes both more accurate and more detailed. In some cases, it is this gathering of user-profile information that is the real purpose of sending out the offers in the first place.

Optional step 320 merely notes that the task sponsor 108 can withdraw the offer before the user completes it. Usually, the task sponsor 108 sets a completion criterion on the task informing the user of how quickly the sponsor 108 needs a response.

The task broker 106 presented above can work with many different end-user devices. A particular embodiment of a method for an end-user device is presented in FIG. 4. In step 400, the end-user device, say the set-top box 114, gathers current activity information about its local user. This type of information is discussed above in relation to step 300 of FIG. 3a.

The end-user device can also gather task-competency information about its user in step 402. This step is considered optional because this information can, and probably should, be gathered from numerous devices with which the user interacts. The end-user device sends this information to the task broker 106.

In step 404, the end-user device receives a job offer from the task broker 106 and presents it to the user in step 406a. Note that if the offer is meant for a specific user (rather than for anyone in the household), then the end-user device may request authentication information from a user at this point.

Note also that the end-user device ultimately decides when to present the offer to the user. This is because the end-user device is closer to the user than is the task broker 106, so the end-user device is more aware of just how interruptible the user currently is. In step 302a of FIG. 3a, the task broker 106 used current-activity information when selecting a task for the user (or a user for a task). In some cases, that may be considered a “coarse-grained” selection, while the end-user device makes a “fine-grained” selection based on its greater knowledge of the user's current actions.

If the offer is addressed to a particular user, then this end-user device may decide, in step 406b, to send the offer on to another device know to be associated with this user. The other device may be more suitable for presenting the offer, for example, or this end-user device may know that the user is currently focusing more attention on the other device.

Step 406c notes that if an acceptance criterion is associated with the offer, then the end-user device makes sure that this criterion is satisfied before it presents the offer to the user.

In step 408 of FIG. 4b, the user gives a completion response to the end-user device which forwards it on to the task broker 106. If the incentive associated with the offer is electronic, then the task broker 106 may deliver it to the end-user device at this point (assuming that the user's completion response is acceptable).

Step 410, like step 320 of FIG. 3b, emphasizes that the offer can be withdrawn before the user completes it.

In view of the many possible embodiments to which the principles of the present invention may be applied, it should be recognized that the embodiments described herein with respect to the drawing figures are meant to be illustrative only and should not be taken as limiting the scope of the invention. For example, almost any types of tasks and incentives can be offered by embodiments of the present invention. Therefore, the invention as described herein contemplates all such embodiments as may come within the scope of the following claims and equivalents thereof.

We claim:

1. In a television-viewing environment, a method for a task broker to send a task to a device associated with a user, the method comprising:
collecting, by the task broker, profile information about the user, the profile information comprising task-competency information and current activity information;
based, at least in part, on the collected task-competency information and on the collected current activity information, selecting, by the task broker, a first offer comprising a first incentive offered in exchange for the user performing a first task; and
sending, by the task broker to the user device, the selected first offer.

2. The method of claim 1 wherein the task broker is selected from the group consisting of: a server, a plurality of servers, a set-top box, a personal computer, a gaming console, and a personal communications device.

3. The method of claim 1 wherein the profile information further comprises an element selected from the group consisting of: information of activities of the user, a preference of the user, demographics of the user, and peer-presence information.

4. The method of claim 1 wherein the selecting is further based on an acceptance criterion set by a task owner.

5. The method of claim 1 wherein the first offer is included in an element selected from the group consisting of: an advertising message, a game display, a menu, a purchase recommendation, a health-service recommendation, a routing recommendation, a television show, an e-mail message, a text message, an application, and a widget.

6. The method of claim 1 wherein the first incentive includes an element selected from the group consisting of: a discount, a coupon, a cash equivalent, a service improvement, access to functionality, access to content, a game clue, a puzzle, a customized service, social presence information, membership in a group, shopping information, control over an experience, control over a peer user's experience, and removal of a disincentive.

7. The method of claim 1 wherein the first incentive is chosen based, at least in part, on an incentive profile of the user, wherein the incentive profile comprises an element selected from the group consisting of: information about a task previously accepted by the user, information about a task previously completed by the user, information about an approval of a completion of a task previously completed by the user, and a context of the first offer.

8. The method of claim 1 wherein sending the first offer comprises associating the first offer with an agent.

9. The method of claim 1:
wherein the first offer further comprises a completion-acceptance criterion; and
wherein the method further comprises:
receiving, by the task broker, a response from the user device to the first offer;
analyzing, by the task broker, the received response; and
if the received response satisfies the completion-acceptance criterion, then providing, by the task broker to the user device, the first incentive.

10. The method of claim 9 further comprising:
updating, by the task broker, the profile information about the user, the updating based, at least in part, on analyzing the received response.

11. The method of claim 10 further comprising:
based, at least in part, on the updated profile information, selecting, by the task broker, a second offer comprising a second incentive offered in exchange for the user performing a second task; and
sending, by the task broker to the user device, the selected second offer.

12. The method of claim 1 further comprising:
receiving, by the task broker from the user device, a completion response to the selected first offer; and
sending, by the task broker to a task sponsor, the completion response.

13. The method of claim 1 further comprising:
sending, by the task broker to the user device, a withdrawal of the selected first offer.

14. A task broker for sending a task to device associated with a user in a television-viewing environment, the task broker comprising:
a transceiver subsystem configured for collecting profile information about the user, the profile information comprising task-competency information and current activity information; and
a processor operatively connected to the transceiver subsystem and configured for:
based, at least in part, on the collected task-competency information and on the collected current activity information, selecting a first offer comprising a first incentive offered in exchange for the user performing a first task; and
sending, via the transceiver subsystem to the user device, the selected first offer.

15. In a television-viewing environment, a method for a first device associated with a user to present a task to the user, the method comprising:
collecting, by the first user device, profile information about the user, the profile information comprising current activity information;
receiving, by the first user device from a task broker, an offer for the user, the offer comprising an incentive offered in exchange for the user performing a task; and
presenting, by the first user device to the user, the offer, a time of presenting based, at least in part, on the collected current activity information.

16. The method of claim 15 further comprising:
collecting, by the first user device, profile information about the user, the profile information comprising task-competency information; and
sending, by the first user device to a task broker, at least some of the collected profile information.

17. The method of claim 15 further comprising:
detecting, by the first user device, a second user device associated with the user;
wherein presenting the offer to the user comprising sending, by the first user device to the second user device, the offer.

18. The method of claim 15 further comprising:
receiving, by the first user device from the user, a completion response to the offer; and
sending, by the first user device to the task broker, the completion response.

19. The method of claim 15 further comprising:
receiving, by the first user device from the task broker, a withdrawal of the offer.

20. The method of claim 15:
wherein the offer further comprises an acceptance criterion set by a task owner; and
wherein the time of presenting is further based on a satisfaction of the acceptance criterion.

21. A first device for presenting a task to a user, the first device comprising:
a transceiver subsystem configured for receiving, from a task broker, an offer for the user, the offer comprising an incentive offered in exchange for the user performing a task; and
a processor operatively connected to the transceiver subsystem and configured for:
collecting profile information about the user, the profile information comprising current activity information; and
presenting, to the user, the offer, a time of presenting based, at least in part, on the collected current activity information.
